(19) United States
(12) Patent Application Publication
(10) Pub. No.: US 2019/0204716 A1
(43) Pub. Date: Jul. 4, 2019

(54) AIRFLOW PHOTOGRAPHIC REFLECTOR

(71) Applicant: John E. Shirilla, Davidson, NC (US)

(72) Inventor: John E. Shirilla, Davidson, NC (US)

(21) Appl. No.: 16/239,362

(22) Filed: Jan. 3, 2019

Related U.S. Application Data
(60) Provisional application No. 62/613,550, filed on Jan. 4, 2018.

(51) Int. Cl. G03B 15/06

(52) U.S. Cl. CPC G03B 15/06

(57) ABSTRACT

A photography reflector device capable of reflecting light while further permitting air to pass through. The reflector device is comprised of an outer frame which is both rigid enough to create a defined outer boundary, while also retaining enough flexibility so as to allow the reflector device to collapse about itself and create a smaller unit for transportation and storage. The central component of the reflector device, which is secured about the outer frame, is comprised of an air-permeable material which has the ability to diffuse light to varying degrees based upon the stitch pattern of the material, thereby altering the reflective capabilities thereof. The reflector device may be of a generally circular nature, where the central material component is stitched to a material covering which is placed about the outer frame.

This non-provisional application claims priority to U.S. Provisional Patent Application Ser. No. 62/613,550, filed on Jan. 4, 2018.

### TECHNICAL FIELD

The present invention relates generally to reflective apparatuses used in the photography industry. More particularly, the present invention relates to a breathable apparatus capable of allowing air to pass through, while further retaining the ability to reflect light for photography purposes.

### BACKGROUND

When taking photographs, particularly at the professional level, it is the usual practice to employ a plurality of light reflective surfaces to accurately control the location at which light is directed onto different parts of the subject. Such light reflective surfaces have been provided on sheets or cards mounted on easels, stands and in some cases simply rested on or against other available objects such as small boxes or the like. In order to see how effective such reflectors are, i.e., will they appear in the picture and is the light being properly directed at the subject from each reflector, it is necessary for the photographer to observe the subject from a location in proximity to the lens of the camera and then to make any necessary changes in the positions of the reflectors. When using the prior art reflectors this positioning and repositioning of the reflectors is often a time-consuming procedure. The presence of disruptive external factors, most notably the wind when shooting in an outdoor environment, can further contribute to this time intensive process of setting up the reflectors.

Different configurations of photographic reflector devices are generally known. In the case of relatively large screens, the form and material of construction can become extremely unwieldy and demanding in terms of expenditure of force in order to properly position such reflectors. At times, the unwieldly size and material of such reflectors can create problems for the photographer. For instance, if the reflector is too large, a second person may be required to hold the reflector screen in place; otherwise there would be a risk that the whole device would fall to the ground. This type of disturbance is further exacerbated when factoring in external factors, such as the presence of wind during an outdoor shoot.

When using photographic reflector devices or screens, particularly with regard to their use in outdoor settings, the weather and other related elements can begin to harm the effectiveness of using such reflector devices. The most notable of these elements is the effect which wind may have on the ability of a reflector device to be properly positioned and retain such a position throughout a particular photo shooting session. Current photographic reflector devices typically utilize a solid sheet design which do not permit an appreciable amount of air to pass through the surface thereof. While such reflectors often provide the desired amount of light being reflected, their use in an outdoor setting becomes increasingly difficult if the weather conditions are not entirely calm (i.e., no wind). As these reflector devices have no way of allowing the wind to pass through their reflective surface, the wind becomes trapped, creating a bellowing effect in which the reflector device may begin to move from that precise location in which it has been positioned. The slightest of wind gusts on an otherwise pleasant day can be all that is needed to knock a reflector device askew, thus slowing down the entire photography process and creating potential dangerous conditions.

In order to combat this problem, many photographers will attempt to modify already existing reflector devices in an attempt to alter their utility to fit the specific needs of the photographer. One of the most common methods is to make a series of cuts or slits into the inner reflective material of a reflector device so as to permit air to pass through. While this may provide for a temporary reprieve under certain conditions, this type of fix does not come without drawbacks. By cutting into or otherwise disrupting the inner reflective material, the ability of the material to reflect or otherwise manipulate light is diminished as a result of the reduction in surface of reflective material. As more and more slits are created on the inner reflective material, the efficiency of the reflector device is sacrificed at the expense of the increased utility of being able to use such a reflector device for a wider variety of uses, such as outdoor shoots. Similarly, when such cuts or slits become present in the reflective material, the ability of the light source to penetrate completely through such gaps can create unwanted effects, such as distributing the light in an unwanted or unexpected manner. Another related drawback is the overall effectiveness of using such slits. Depending upon the placement and number of slits present on a given reflector device, the ability to effectively pass air through the reflector device can vary greatly. For example, a large reflector device which has only a few slits placed about the outer edges will not be able to effectively pass a sufficient amount of air to prevent the reflector device from being agitated by a gust of wind. Therefore, in order to adequately allow for such air passage, additional slits are required throughout the entire body of the inner reflective material. In doing so, as mentioned above, the amount of light capable of being reflected is greatly reduced and manipulating capabilities of the reflector device must be sacrificed.

While the problems with prior art devices discussed above are widely applicable to most reflector devices, they are considerably more noticeable when using an umbrella reflector. As anyone who has ever opened an umbrella in a windy environment knows, the ability to control such a device decreases exponentially with the speed of the wind. Umbrella reflectors used in the photography industry are no different. However, as opposed to a traditional umbrella, which is tasked with keeping rain and other elements from penetrating and hitting the user, an umbrella reflector for photography purposes is tasked with only manipulating the incoming light in a desired manner by way of the inner surface. Therefore, while sharing similar structural limitations based upon their design, the two devices serve ultimately different purposes.

Therefore, a need exists for a reflector device which is able to permit air and other elements to pass through the reflective surface to such a degree that the reflector is not moved or otherwise altered in such a manner so as to hinder its effectiveness in reflecting light for photographic purposes. Additionally, the reflector screen is capable of being any number of different sizes, and further collapsible or otherwise able to be deconstructed such that a single user may store and/or transport the reflector screen with relative ease.

### SUMMARY

The present invention relates to various improvements to reflector devices which are commonly used in the photography industry. However, various embodiments of the present invention may permit the use of such reflector devices for purposes other than those relating to photography.

The photography industry has long utilized various devices to create indirect light sources to aid in and control the reflection of light so as to provide for better results. Among those most commonly used devices are that of reflector devices comprising a flexible sheet-like design. Such reflector devices are often lightweight and easily transported from one shooting location to another. The use of a reflective material, such as a reflective cloth or other similar material, is most often used. However, the inability of such materials to allow for the passage of air causes the material to trap any air with which it comes into contact. The result of this “trapping” of air may result in the reflector device not properly reflecting light according to the desires of the photographer or may alternatively cause the reflector device to be uprooted and thereby moved about to an unwanted location.

Rather than manipulating existing reflector devices such that they are able to permit the passage of air, such as by cutting a series of holes or slits through the inner reflective material, the present invention utilizes an inner reflective material which is itself capable of permitting air to pass through, thus retaining the light reflective properties which are sought by photographers. When used for outdoor applications, air, wind, and other similar elements of nature are capable of passing directly through the material from which the reflector device is manufactured, thus allowing the reflector device to be positioned according to the desire of the photographer, and capable of retaining such a position in the presence of adverse weather conditions (such as strong gusts of wind, etc.).

Further aspects of the present invention allow for the reflector device to be collapsed or otherwise deconstructed such that it may be easily transported and stored by a single individual. The reflector device may come in any different number of shapes and sizes. Based upon the particular shape and/or size of the particular reflector device, the ability of the device to be collapsed or otherwise deconstructed may vary.

### BRIEF DESCRIPTION OF THE DRAWINGS

The accompanying drawings in the following description illustrate various embodiments of the present disclosure.

FIG. 1 is a front view of a photographic reflective device made from an air-permeable material;

FIG. 2 is a perspective view of a photographic reflective device made from an air-permeable material;

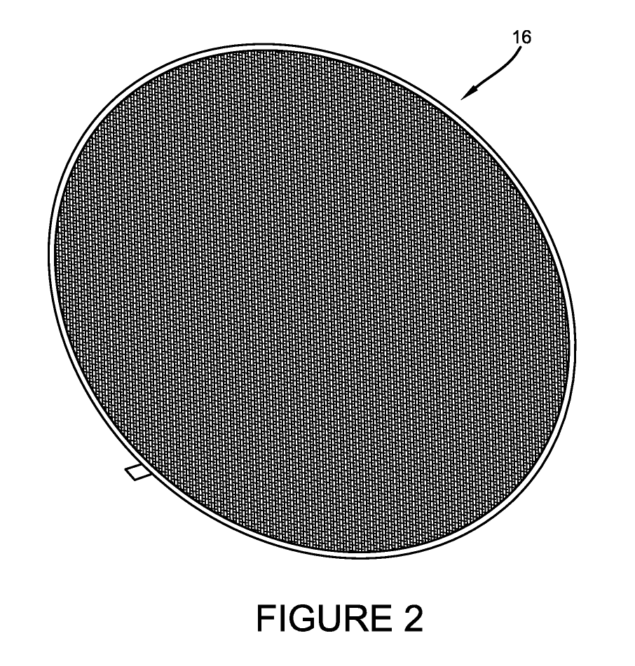

FIG. 3 is a side view of a photographic reflective device made from an air-permeable material;

FIG. 4 is a perspective view of an air-permeable reflective umbrella;

FIG. 5 is a front view of a photographic reflective device made from an air-permeable material with handles.

### DETAILED DESCRIPTION

Most light manipulative devices used to aid in photography are constructed from a translucent fabric or similar material which is able to diffuse or reflect light at a multitude of angles incident to the surface or feature being photographed. Among those materials most commonly used are silver, gold, black, and white colored fabrics which reflect manipulate light in a given manner. The exact color and light-manipulative properties of such materials are readily understood by those having skill in the art, and as such are typically selected based upon the specific desires of the photographer during a particular photo shoot.

The present invention is capable of being used in combination with any of the aforementioned light-manipulative materials. According to one example, a white inner reflective material is used to diffuse the incoming light, providing a soft, clean light on the subject. Such a material may be used in order to compliment an already existing light source, as is common during outdoor shoots when the sun is present. According to another example, a gold or silver inner reflective material may be used so as to cast a warmer light onto the subject. By reflecting a greater amount of light at the subject, such materials are used to compensate for those environments where there may not be as much natural or artificial light readily available. Yet another example may utilize a black inner material which is placed between the light source and the subject, sometimes referred to as a “go-between”. Rather than reflecting the light onto the subject, as is seen when using a lighter colored reflective material (such as gold or silver), a black inner material is used to bounce or deflect the light away from the subject. This type of material may be used to lessen the amount of light which is directed at the subject.

A number of different physical designs and frameworks are capable of supporting an air-permeable reflector device to be used for photography purposes. One of the most commonly utilized frameworks for such reflector devices, sometimes referred to as board reflectors, plane reflectors, or “bounce boards,” is that of a circular design which houses such a semi-translucent fabric in the center. However, various other shapes and designs, such as a rectangle, square, or otherwise, may be used. Such board reflectors are often available in varying sizes so as to service the particular needs of a photographer. A semi-translucent fabric as discussed above is stretched about an outer frame which comprises a rigid outer structure. The semi-translucent fabric is stretched such that it does not sag or otherwise significantly depress from the plane of the outer structure and is at relevant tension with regard to the rigid outer structure.

The primary limitation of any of these designs is that the semi-translucent fabric does not permit air to pass through. When such reflector devices are used in an outdoor setting, they trap the passing wind and create a bellowing effect upon which the reflector device begins to blow about. The inability of air, most notably with respect to wind which is inevitably encountered during most outdoor photo shoots, to pass through the reflector device places a noticeable constraint on the ability of a photographer to utilize such reflector devices, in particular, a lone photographer who does not have a crew or other group of individuals on hand to look after and constantly adjust the reflector device(s).

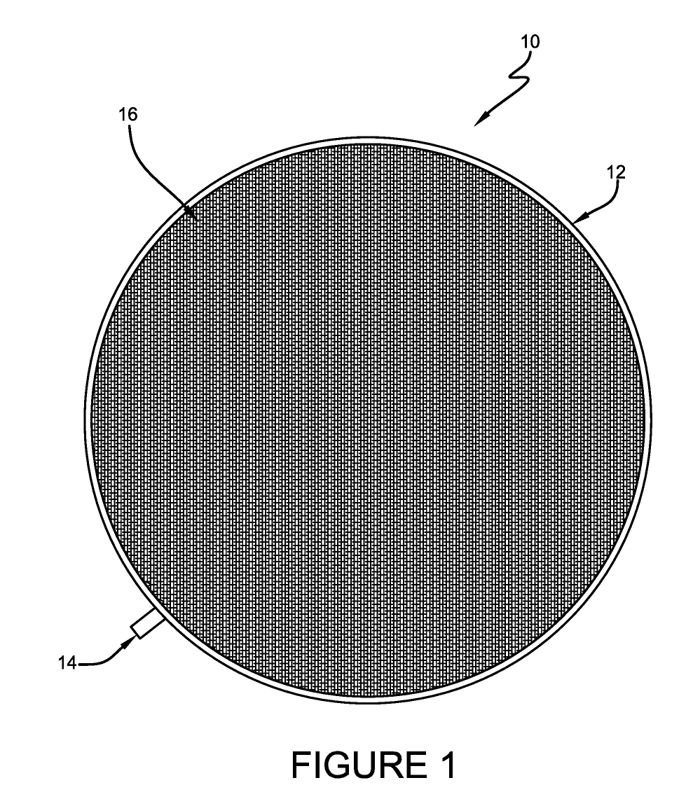

Referring now to FIG. 1, a substantially circular reflector device 10 is shown. However, various other embodiments will allow for the use of various other shapes (including but not limited to an oval or ellipse) of varying sizes, as is contemplated by those having skill in the art. According to the embodiment shown in FIG. 1, the exterior of the reflector device 10 is comprised of a rigid outer frame 12. The rigid outer frame 12 may be constructed from any durable material which is capable of being configured according to the desired shape of the reflector device. While the rigid outer frame 12 is able to retain a defined shape, it retains a relative degree of flexibility when subjected to force of compression such that it will not readily break, or “snap”. Such material may include a flexible plastic, a soft metal or similar material, a tubing material which is capable of being formed to a desired shape, or any other malleable material capable of being formed into, and retaining, an exterior frame. The rigid outer frame 12 is then covered with a cloth, fabric, or other similar material of an elastic or otherwise expandable nature.

Secured to the covering of the rigid outer frame 12 may be any different number of tags, loops, tabs, or other similar means of securement. According to the embodiment shown in FIG. 1, a single loop 14 is placed around the rigid outer frame 12 and secured by way of stitching. The loop 14 may be used for any different number of uses as identified by those having skill in the art. One such use may be for securing the reflector device 10 to a particular surface during use such that it remains in a desired location. The loop 14 allows for the reflector device 10 to be clipped, clamped, or otherwise affixed at a particular location, including at a particular height above the ground and particular angle relative to the subject of the photograph.

With continued reference to FIG. 1, a reflective material 16 is stretched about the interior of the rigid outer frame 12. The reflective material may be secured to the rigid outer frame 12 by any means available to those having skill in the art which will not inhibit the reflective properties of the material. According to the embodiment shown in FIG. 1, the reflective material 16 is sewn, or stitched, to the cloth-like material which covers the rigid outer frame 12.

The reflective material 16 is constructed of a material which is able to both reflect light and allow air to pass through relatively uninhibited. Material of such a nature may come in any different variety of colors, such as gold, silver, white, or any other colors having unique reflective properties, much the same as those materials currently used which do not possess the air-permeability of the present invention.

According to one embodiment, the reflective material 16 is comprised of Aluminet reflective shade fabric, manufactured by Green-tek and readily available from a wide variety of retailers around the world. This highly reflective shade fabric is available in any different number of sizes and stitch patterns, as well as varying degrees of diffused light transmission capabilities ranging anywhere from as low as 32% to as high as 79%. As used here, the term “diffused light” is meant only to illustrate differences in the various types of reflective material capable of being used based on their ability to allow certain levels of light to pass through, but not to imply that the reflective material is being used as a light diffuser (i.e., used to spread or scatter the light). Rather, the reflective material of such embodiments is still being used to reflect the light, but still does allow for minimal levels of light to diffuse through its surface. However, additional light diffusion rates outside of this range may be chosen at the discretion of those having skill in the art. The particular reflective material 16 may thus be chosen as a result of any different number of factors, such as the desired light diffusion rate, the desired air passage rate, the flexibility of the stitch pattern, or any combination of these or other factors, as identified by those having skill in the relevant art. Various other types of air-permeable fabrics or materials may be used which possess light reflective properties similar to that of Aluminet or other commonly used reflective materials in the industry, as identified by those having skill in the relevant art.

Reflective shade material having air permeability, such as Aluminet reflective shading, is often used in the agricultural and crop industries as a means of providing shade over a greenhouse or other similar roof-like structure, while simultaneously allowing for air to pass through the stitched material. The ability of the material to reflect incoming light, while only allowing a designated amount of such light to diffuse through, results in a shaded, or at least partially shaded, environment when the material is used on a roof or other similar overhang. By altering the stitch pattern, different rates of diffusion and air permeability are able to be accomplished as needed for different applications. A similar principle may be applied to the use of Aluminet or another similar material in the photography industry. By altering the stitch pattern of the reflective material 16, different rates of diffusion may be experienced, resulting in devices of varying reflective abilities, so as to accommodate the various needs of the photographer. According to one example, a photographer who routinely operates in a windy environment may choose a wider knit pattern so as to allow increased air permeability at the expense of decreased light diffusion, which thereby effects the resulting reflectivity. Such a configuration would allow the reflector device 10 to withstand increased wind speeds without experiencing the negative effects of the reflector device 10 bellowing or otherwise being appreciably agitated by trapping the wind. Conversely, a photographer who routinely operates in an indoor environment free from the elements, but who occasionally incorporates an outdoor shoot and would like to be adequately prepared, could opt for a tighter knit pattern which provides for decreased air permeability in order to obtain a higher rate of light being diffused, which thereby effects the resulting reflectivity.

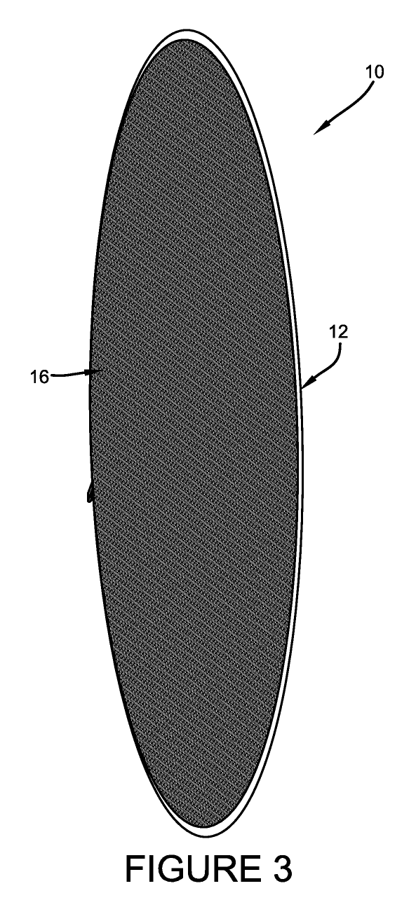

With reference now to FIG. 3, the reflective material 16 may be seen stitched to the rigid outer frame 12. While the exact dimensions of the rigid outer frame 12 may vary according to the amount of support required of the reflective material 16, the rigid outer frame 12 may be generally between ¼ inch and ½ inch in thickness. The material which encompasses that of the rigid outer frame 12 onto which the reflective material 16 is attached may also very according to the specific needs of the reflector device 10, but may generally measure, from the exterior surface of the rigid outer frame 12 to that distance of the reflective material 16 to which the material encroaches, between approximately ⅛ inch and 1 inch.

The reflector device 10 is capable of being collapsed, or otherwise partially deconstructed, so as to be more easily transported or stored. With continued reference to FIG. 3, the relatively thin dimensions of the rigid outer surface 12 allow for the rigid outer surface 12, when subjected to a sufficient amount of force about opposing distal ends, to collapse upon one another and thereby compress the reflector device 10. When in such a compressed state, the reflector device 10 may become only a fraction of the size of the device when in the static state in which it is used for photography purposes. A sufficient amount of force needed to compress the reflector device 10 is dependent upon the specific material out of which the rigid outer frame 12 is constructed, but will generally not be more than that which the average person may easily apply by grasping the reflector device 10 about opposing sides and attempting to cause said opposing sides to come into contact with one another.

According to one embodiment, the reflector device 10 is circular in nature. When applying sufficient force to place the reflector device 10 in the compressed state, opposing ends of the rigid outer frame 12 may be collapsed onto one another and the reflector device 10 may then be folded about itself so as to create a smaller, but yet still relatively circular, device. This smaller, compressed device is then able to be more easily transported between different locations, as well as conveniently stored in a vehicle or other location as needed. According to other embodiments, where the reflector device 10 is of a different shape, such as that of a rectangle, opposing ends of the reflector device 10 may be similarly compressed about one another so as to create a device of a similar nature, but having a smaller overall dimension.

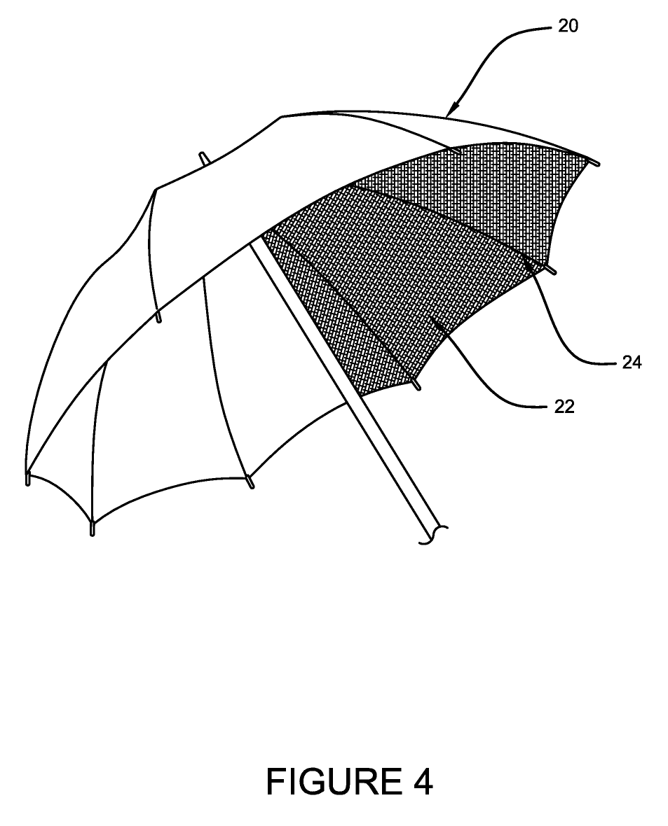

With reference now to FIG. 4, an air-permeable reflective umbrella 20 is shown. The umbrella may be generally defined by having a central shaft 26, from which a series of ribs 24 extend therefrom. An inner reflective material 22, such as Aluminet reflective shade cloth as discussed above, may be affixed to the ribs 24 of the umbrella 20. As used herein, the term “inner” is meant to define the reflective material as being disposed in between that of the ribs 24 of the umbrella. The color of the inner reflective material 22, and accordingly the reflective properties thereof, may vary according to the specific needs of the photographer. Various embodiments may include a white material for diffusing the light, a gold or silver material for reflecting the light, a black material for blocking or partially blocking the light, or any other combination of color and light manipulating properties. The inner reflective material 22 may be sewn or otherwise affixed to the ribs 24 by any means identified by those having skill in the art. According to one embodiment, the reflective side of the inner reflective material 22 is positioned such that it faces towards the inside of the umbrella when in an option configuration. When utilizing the umbrella for its reflective capabilities according to such an embodiment, the umbrella is positioned so that a light source is exposed to the reflective side of the inner reflective material 22 such that it may reflect light back at the light source. The air-permeable reflective umbrella 20 further retains all functions typically associated with other standard reflective umbrellas, including but not limited to the ability to collapse or otherwise fold about itself for purposes of transportation and storage.

With continued reference to FIG. 4, the umbrella 20 may thus be used in accordance with those photography practices associated with a standard reflective umbrella. When used for outdoor shoots, the air-permeable reflective umbrella 20 is thus able to allow air to pass directly through the stitched pattern of the inner reflective material 22, without the need to cut or otherwise modify such material. This configuration allows for the air-permeable reflective umbrella 20 to retain the entirety of those light reflective properties associated with the inner reflective material 22, rather than having to choose between sacrificing either the effectiveness of the umbrella or the utility for which it may be used.

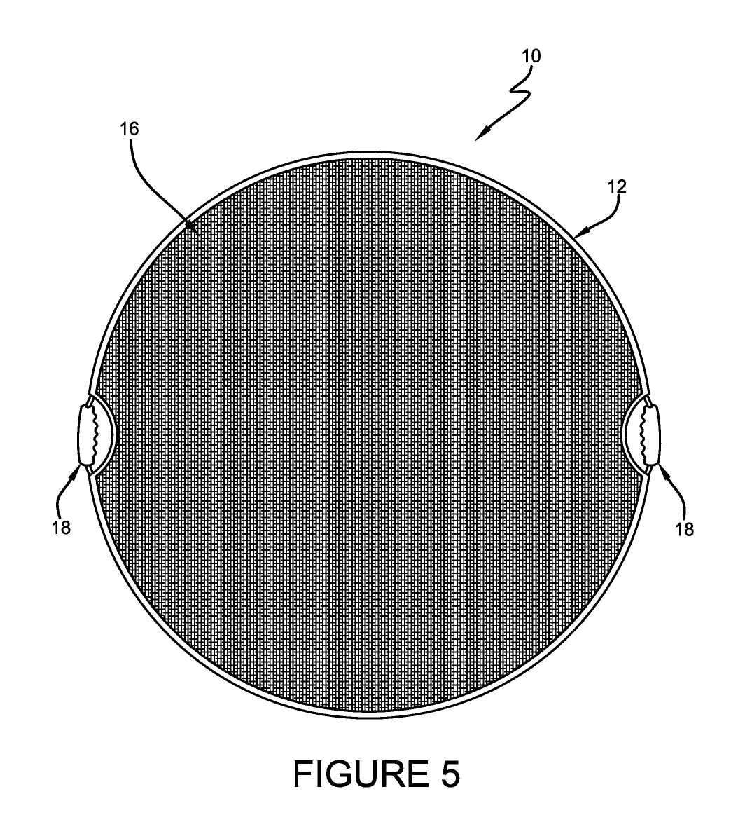

With reference now to FIG. 5, shown is a front view of an alternative embodiment of the reflector device 10. The embodiment shown therein demonstrates the use of two handles 18 being clamped to the rigid outer frame 12 at opposing distal ends as an alternative means for securing the reflector device 10. The handles 18 may be used by an operator as a means for affixing the reflector device 10 to the surfaces of the operator's hands through the operator's gripping of the handles 18. The operator of the reflector device 10 may then utilize this securement of the reflector device 10 to their hands as a means for ensuring the reflector device 10 remains in a desired location, at a particular height above the ground and at a particular angle relative to the subject of the photograph. The handles 18 serve a purpose identical to that of the single loop 14 described in paragraph 24. The use of the handles 18 is not limited to the embodiment shown and may still function through the means described herein with both more or less handles affixed to the outer rigid frame 12 at any location relative to the reflector device 10 and other handles 18. The utility of the handles is not limited to the use of two handles placed at opposite distal ends and those having skill in the art will recognize the variety of useful combinations which could be created through the clamping of a handle 18 to the outer rigid frame 12 of the reflector device 10. (these handles are not part of the invention)

Additional variations and adaptations of air-permeable reflective devices may be accomplished by applying those same principles as discussed by the present disclosure, such as the use of an air-permeable inner reflective material as applied to various other frameworks or devices for use in photography or other related applications.

As described above, the present disclosure has been described in association with various aspects thereof and it is understood that many changes and modifications to the described aspects can be carried out without departing from the scope and the spirit of the present disclosure that is intended to be limited only by the appended claims.

Having thus described the invention, it is now claimed:

What is claimed is:

1. A device comprising:
a frame having a rigid outer portion, and;
a light-reflective fabric adhered to said frame, wherein said fabric is permeable to the air.

2. The device of claim 1, wherein said frame is any shape as defined by the edges of the rigid outer portion.

3. The device of claim 1, wherein said frame is collapsible.

4. The device of claim 1, wherein said frame is flexible plastic, soft metal, tubing, or any malleable material capable of retaining an exterior frame.

5. The device of claim 1, wherein said frame is circular or oval and the fabric is positioned about the middle of said frame.

6. The device of claim 5, wherein the rigid outer portion of said frame is encompassed by an elastic material.

7. The device of claim 6, wherein the fabric is stitched to the elastic material encompassing the rigid outer portion of said frame.

8. The device of claim 1, wherein said frame is elliptical and the fabric is positioned about the middle of said frame.

9. The device of claim 7, further comprising at least one handle affixed to the elastic material encompassing the rigid outer portion of said frame.

10. The device of claim 7, further comprising two handles, positioned opposite each other, affixed to the elastic material encompassing the rigid outer portion of said frame.

11. The device of claim 1, wherein the fabric is Aluminet reflective shade fabric.

12. The device of claim 11, wherein the Aluminet reflective shade fabric has a diffused light transmission between 32% and 79%.

13. The device of claim 1, wherein the fabric has a wide knit pattern allowing for substantial air passage.

14. The device of claim 1, wherein the fabric has a tight knit pattern allowing for minimal air passage.

15. The device of claim 1, wherein the thickness of the rigid outer portion of the frame is between approximately ¼ and ½ inch.

16. The device of claim 1, wherein said fabric is one of the following colors:
silver;
gold, or;
white.

17. A device comprising:
a frame, said frame having a central shaft with at least one rib extending outward therefrom, and;
a light-reflective fabric adhered to the at least one rib of said frame, wherein said fabric is permeable to the air.

18. The device of claim 17, wherein the frame is collapsible.

19. The device of claim 17, wherein the fabric is Aluminet reflective shade fabric.

20. A method of reflecting light in the presence of wind, comprising the steps of:
affixing a light-reflective fabric to a frame, wherein said light-reflective fabric is permeable to the air;
placing the frame in an environment where wind is present;
arranging the frame such that it is located between a light source and a subject, and;
orienting the frame such that it is able to reflect incoming light from the light source relative to the subject;
wherein the frame is able to be so arranged by a single individual and does not require any additional equipment or any continuous modification to retain such an arrangement and orientation.
